(19) United States
(12) Patent Application Publication
(10) Pub. No.: US 2024/0362038 A1
(43) Pub. Date: Oct. 31, 2024

(54) FUNCTION RECOMMENDATION METHOD, DEVICE, AND MEDIUM

(71) Applicant: BOE Technology Group Co., Ltd., Beijing (CN)

(72) Inventors: Haifeng Xu, Beijing (CN); Guangwei Huang, Beijing (CN); Bingqian Wang, Beijing (CN)

(73) Assignee: BOE Technology Group Co., Ltd., Beijing (CN)

(21) Appl. No.: 18/639,183

(22) Filed: Apr. 18, 2024

Related U.S. Application Data
(63) Continuation of application No. PCT/CN2023/091048, filed on Apr. 27, 2023.

(51) Int. Cl. G06F 9/451; G06F 3/04883; G10L 15/02

(52) U.S. Cl. CPC G06F 9/451; G06F 3/04883; G10L 15/02

(57) ABSTRACT

The present disclosure relates to the technical field of artificial intelligence, in particular to a function recommendation method and apparatus, a device, a program and a medium. The function recommendation method includes: acquiring target input information input by a user during executing of a first application; performing semantic parsing on the target input information to obtain target control information; determining at least one second application that satisfies a recommendation condition based on the target control information; and displaying a shortcut control corresponding to the at least one second application on a display interface of a terminal device.

### TECHNICAL FIELD

The present disclosure relates to the technical field of artificial intelligence, in particular to a function recommendation method, a device, and a medium.

### BACKGROUND

In an application process of a terminal device, a user can interact with the terminal device by clicking instructions, so that an application currently needed by the user in the terminal device and a functional module of the application can be called to realize corresponding functions.

However, the steps for uses to call multi-level functions by frequent clicking instructions (clicking of a mouse, or clicking of a touch, etc.) are cumbersome, and interaction between the user and the terminal device requires uses to devote dedicated attention, which results in breaking of a current operating environment by the user, with poor user experience. Therefore, it has become an urgent technical problem for persons skilled in the art to realize non-sensory interaction and improve the user experience.

### SUMMARY

Embodiments of the present disclosure provide a function recommendation method and apparatus, a device, a program and a medium, which aim at solving a problem of making function recommendation and realizing non-sensory interaction without breaking a current operating environment.

In a first aspect of an embodiment of the present disclosure, a function recommendation method is provided, which includes:
acquiring target input information input by a user during executing of a first application;
performing semantic parsing on the target input information to obtain target control information;
determining at least one second application that satisfies a recommendation condition based on the target control information; and
displaying a shortcut control corresponding to the at least one second application on a display interface of a terminal device.

In an optional implementation, after displaying the shortcut control corresponding to the least second application on the display interface of the terminal device, the method further comprises:
opening an application interface of the at least one second application in response to an operation of the user on a first shortcut control; and
receiving first configuration information input by the user and switching the application interface of the at least one second application to a functional interface for executing the first configuration information.

In an optional implementation, after determining the at least one second application that satisfies the recommendation condition, the method further comprises:
performing configuration information identification on the target input information to obtain second configuration information;
determining a target application based on the second application and the second configuration information, wherein the target application is a second application capable of executing the target control information according to the second configuration information;
determining a target function, wherein the target function is to control the target application to execute instructions corresponding to the target control information, and the target function is set based on the second configuration information; and
displaying a shortcut control corresponding to the target function on the display interface of the terminal device.

In an optional implementation, the target input information comprises third input information, and the method comprises:
performing configuration information identification on the third input information to obtain second configuration information;
opening an application interface of the at least one second application in response to an operation of the user on a first shortcut control; and
configuring the at least one second application based on the second configuration information, so as to switch the application interface of the at least one second application to a functional interface for executing the second configuration information.

In an optional implementation, the second application is a countdown application.

In an optional implementation, the target input information comprises first input information and second input information, and the performing the semantic parsing on the target input information to obtain the target control information comprises:
performing the semantic parsing on the first input information to obtain first target control information; and
performing the semantic parsing on the second input information to obtain second target control information;
wherein the determining the at least one second application that satisfies the recommendation condition based on the target control information comprises:
determining at least one second application for the first input information that satisfies the recommendation condition based on the first target control information; and
determining at least one second application for the second input information that satisfies the recommendation condition based on the second target control information;
wherein the displaying the shortcut control corresponding to the at least one second application on the display interface of the terminal device comprises:
displaying a shortcut control corresponding to the at least one second application for the second input information and a shortcut control corresponding to the at least one second application for the first input information on the display interface of the terminal device at the same time.

In an optional implementation, the target input information comprises the first input information and the second input information, and the displaying the shortcut control corresponding to the at least one second application on the display interface of the terminal device comprises:
opening an application interface of the at least one second application for the first input information on the display interface in response to an operation of the user on the first shortcut control; and
closing the application interface of the at least one second application for the first input information, and opening an application interface of the at least one second application for the second input information on the display interface, in response to an operation of the user on the second shortcut control.

In an optional implementation, after determining the at least one second application that satisfies the recommendation condition, the method further comprises:
determining a third application that satisfies the recommendation condition based on the target control information when the terminal device is in a network connection state, wherein the third application is a cloud platform application; and
displaying the shortcut control corresponding to the at least one second application and a shortcut control corresponding to the third application on the display interface of the terminal device at the same time.

In an optional implementation, the method further comprises:
displaying prompt information on the display interface of the terminal device when the terminal device is in a non-network connection state, wherein the prompt information is used for prompting the user to check a network state of the terminal device;
generating a network setting icon on the display interface of the terminal device; and
displaying a network setting interface on the display interface of the terminal device in response to an interactive operation between the user and the network setting icon.

In an optional implementation, the determining the at least one second application that satisfies the recommendation condition based on the target control information comprises:
matching the target control information with a plurality of applications in the terminal device to obtain first matching degrees; and
acquiring the at least one second application that satisfies the recommendation condition based on the first matching degrees.

In an optional implementation, after obtaining the target control information, the method further comprises:
matching the target control information with a plurality of applications in the terminal device to obtain first matching degrees; and
acquiring at least one candidate second application that satisfies the recommendation condition based on the first matching degrees, wherein the recommendation condition is that the first matching degree is greater than a first matching threshold; and
sequentially displaying a shortcut control corresponding to the at least one candidate second application on the display interface of the terminal device according to a sequence of the first matching degrees of the at least one candidate second application.

In an optional implementation, the method further comprises:
acquiring the target input information input by the user during the executing of the first application, wherein the first application is a handwriting application, the target input information is handwriting input information, and the handwriting input information is text information obtained by character recognition for handwriting trajectory point information;
performing the semantic parsing on the handwriting input information to obtain the target control information;
determining at least one of the second applications that satisfies the recommendation condition based on the target control information; and
displaying the shortcut control corresponding to the at least one second application on the application interface of the handwriting application.

In an optional implementation, the handwritten input information is acquired by:
acquiring the handwriting trajectory point information input by the user, wherein the handwriting trajectory point information comprises at least one of: coordinate values of trajectory points, timestamps of the trajectory points, and states of the trajectory points;
acquiring a handwriting trajectory line graph based on the handwriting trajectory point information;
inputting the handwriting trajectory point information into a first branch of a character recognition network to obtain a first input feature, wherein the first input feature comprises time information of the trajectory points of the handwriting trajectory point information;
inputting the handwriting trajectory line graph into a second branch of the character recognition network to obtain a second input feature, wherein the second input feature does not comprise the time information of the trajectory points of the handwriting trajectory point information; and
combining the first input feature with the second input feature to obtain the handwritten input information.

In an optional implementation, the target input information is voice input information, and the voice input information is acquired by:
acquiring voice information input by the user;
performing feature extraction on the voice information to obtain voice features; and
decoding the voice features based on a voice recognition model to obtain the voice input information.

In an optional implementation, the performing the semantic parsing on the target input information to obtain the target control information comprises:
acquiring at least one clause based on the target input information;
performing word segmentation on a clause in the target input information to obtain a plurality of segmented words;
matching each of the plurality of segmented words with candidate control information to obtain a second matching degree; and
taking candidate control information with a second matching degree greater than a second matching threshold as the target control information.

In an optional implementation, the candidate control information is acquired by:
acquiring a function type of each application in the terminal device;
grouping all of applications in the terminal device according to the functional type of each of the applications in the terminal device to obtain at least one application cluster, wherein functional types of applications in each application cluster are the same; and
taking a function type corresponding to each application cluster as one of the candidate control information.

In an optional implementation, after obtaining the plurality of segmented words, the method further comprises:
taking a left segmented word and a right segmented word corresponding to each segmented word in the clause as classification input data to obtain a classification input data set; and
inputting the classification input data set into a classification model, and performing semantic parsing on the classification input data set based on the classification model to acquire the target control information.

In a second aspect, embodiments of the present disclosure provide a function recommendation apparatus, comprising:
a target input information acquisition module configured for acquiring target input information input by a user during executing of a first application;
a semantic parsing module configured for performing semantic parsing on the target input information to obtain target control information;
a recommendation application module configured for determining at least one second application that satisfies a recommendation condition based on the target control information; and
a display module configured for displaying a shortcut control corresponding to the second application on a display interface of a terminal device.

In an optional implementation, the apparatus further includes:
an application opening module for opening an application interface of the second application in response to an operation of the user on a first shortcut control; and
an interface switching module configured for receiving first configuration information input by the user and switching the application interface of the second application to a functional interface for executing the first configuration information.

In an optional implementation, the apparatus further includes:
a configuration information acquisition module configured for performing configuration information identification on the target input information to obtain second configuration information;
a target application module configured for determining a target application based on the second application and the second configuration information, wherein the target application is a second application capable of executing the target control information according to the second configuration information;
a target function module configured for determining a target function, wherein the target function is to control the target application to execute instructions corresponding to the target control information, and the target function is set based on the second configuration information; and
a second display module configured for displaying a shortcut control corresponding to the target function on the display interface of the terminal device.

In an optional implementation, the apparatus further includes:
a configuration acquisition module configured for performing configuration information identification on third input information to obtain second configuration information;
an opening module for opening an application interface of the second application in response to an operation of the user on a first shortcut control; and
an application configuration module configured for configuring the second application based on the second configuration information, so as to switch the application interface of the second application to a functional interface for executing the second configuration information.

In an optional implementation, the semantic parsing module includes:
a first parsing submodule configured for performing the semantic parsing on the first input information to obtain first target control information; and
a second parsing submodule configured for performing the semantic parsing on the second input information to obtain second target control information;
the recommendation application module includes:
a first recommendation application submodule configured for determining at least one second application for the first input information that satisfies the recommendation condition based on the first target control information; and
a second recommendation application submodule configured for determining at least one second application for the second input information that satisfies the recommendation condition based on the second target control information;
the display module includes:
a third display submodule configured for displaying a shortcut control corresponding to the second application for the second input information and a shortcut control corresponding to the second application for the first input information on the display interface of the terminal device at the same time.

In an optional implementation, the display module includes:
a first control submodule configured for opening an application interface of the second application for the first input information on the display interface in response to an operation of the user on the first shortcut control; and
a second control submodule configured for closing the application interface of the at least one second application for the first input information and opening an application interface of the at least one second application for the second input information on the display interface, in response to an operation of the user on the second shortcut control.

In an optional implementation, the apparatus further includes:
a network recommendation application module configured for determining a third application that satisfies the recommendation condition based on the target control information when the terminal device is in a network connection state, wherein the third application is a cloud platform application; and
a fourth display module configured for displaying the shortcut control corresponding to the second application and a shortcut control corresponding to the third application on the display interface of the terminal device at the same time.

In an optional implementation, the apparatus further includes:
a prompt module configured for displaying prompt information on the display interface of the terminal device when the terminal device is in a non-network connection state, wherein the prompt information is used for prompting the user to check a network state of the terminal device;
a network setting display module configured for generating a network setting icon on the display interface of the terminal device; and
a fifth display module configured for displaying a network setting interface on the display interface of the terminal device in response to an interactive operation between the user and the network setting icon.

In an optional implementation, the recommendation application module includes:
a first matching submodule configured for matching the target control information with a plurality of applications in the terminal device to obtain first matching degrees; and
a recommendation application submodule configured for acquiring the at least one second applications that satisfies the recommendation condition based on the first matching degrees.

In an optional implementation, the apparatus further includes:
a first matching module configured for matching the target control information with a plurality of applications in the terminal device to obtain first matching degrees; and
a candidate second application acquisition module configured for acquiring at least one candidate second application that satisfies the recommendation condition based on the first matching degrees, wherein the recommendation condition is that the first matching degree is greater than a first matching threshold; and
a fifth display module configured for sequentially displaying a shortcut control corresponding to the at least one candidate second application on the display interface of the terminal device according to a sequence of the first matching degrees of the at least one candidate second application.

In an optional implementation, the apparatus further includes:
a handwriting input information acquisition module configured for acquiring the target input information input by the user during the executing of the first application, wherein the first application is a handwriting application, the target input information is handwriting input information, and the handwriting input information being text information obtained by character recognition for
a second semantic parsing module configured for performing the semantic parsing on the handwriting input information to obtain the target control information;
a third recommendation application module configured for determining at least one of the second applications that satisfies the recommendation condition based on the target control information; and
a sixth display module configured for displaying the shortcut control corresponding to the at least one second application on the application interface of the handwriting application.

In an optional implementation, the handwriting input information acquisition module includes:
a handwriting information acquisition submodule configured for acquiring the handwriting trajectory point information input by the user, wherein the handwriting trajectory point information includes at least one of: coordinate values of trajectory points, timestamps of the trajectory points, and states of the trajectory points;
a line graph acquisition submodule configured for acquiring a handwriting trajectory line graph based on the handwriting trajectory point information;
a first input feature submodule configured for inputting the handwriting trajectory point information into a first branch of a character recognition network to obtain a first input feature, wherein the first input feature includes time information of the trajectory points of the handwriting trajectory point information;
a second input feature submodule configured for inputting the handwriting trajectory line graph into a second branch of the character recognition network to obtain a second input feature, wherein the second input feature not includes the time information of the trajectory points of the handwriting trajectory point information; and
a combination submodule for combining the first input feature with the second input feature to obtain the handwritten input information.

In an optional implementation, the target input information acquisition module further includes:
a voice information acquisition submodule configured for acquiring voice information input by the user;
a feature extraction submodule configured for performing feature extraction on the voice information to obtain voice features; and
a decoding submodule configured for decoding the voice features based on a voice recognition model to obtain the voice input information.

In an optional implementation, the semantic parsing module includes:
a sentence splitting submodule configured for acquiring at least one clause based on the target input information;
a word segmentation submodule configured for performing word segmentation on a clause in the target input information to obtain a plurality of segmented words;
a second matching submodule configured for matching each of the plurality of segmented words with candidate control information to obtain a second matching degree; and
a target control information acquisition submodule configured for taking candidate control information with a second matching degree greater than a second matching threshold as the target control information.

In an optional implementation, the second matching submodule includes:
an application acquisition subunit configured for acquiring all of applications in the terminal device, with tags for representing functional types of the applications in the terminal device;
an application clustering subunit configured for grouping all of the applications in the terminal device according to a functional type of each of the applications in the terminal device to obtain at least one application cluster, wherein functional types of applications in each application cluster are the same; and
a candidate control information acquisition subunit configured for taking a function type corresponding to each application cluster as one of the candidate control information.

In an optional implementation, the semantic parsing module further includes:
a classification input data acquisition submodule configured for taking a left segmented word and a right segmented word corresponding to each segmented word in the clause as classification input data to obtain a classification input data set; and
a semantic parsing submodule configured for inputting the classification input data set into a classification model, performing semantic parsing on the classification input data set based on the classification model to acquire the target control information.

In a third aspect, embodiments of the present disclosure provide a computing and processing device, comprising:
a memory with computer readable codes stored therein; and
one or more processors, wherein the computing and processing device executes the function recommendation method according to any one as described in the first aspect when the computer readable code is executed by the one or more processors.

In a fourth aspect, embodiments of the present disclosure provide a computer program, comprising computer readable code, which, when executed on a computing and processing device, causes the computing and processing device to execute the function recommendation method according to any one as described in the first aspect.

In a fifth aspect, embodiments of the present disclosure provide a computer readable medium, storing the computer program as described in the fourth aspect.

### Beneficial Effects:

A function recommendation method and apparatus, a device, a program and a medium are provided in the embodiments of the present disclosure. The function recommendation method includes: acquiring the target input information input by the user during executing of the first application; performing the semantic parsing on the target input information to obtain the target control information; determining the at least one second application that satisfies the recommendation condition based on the target control information; and displaying the shortcut control corresponding to the at least one second application on the display interface of the terminal device.

According to the embodiment of the present disclosure, the target control information is determined by the target input information during executing of the first application by the user, and a related application corresponding to the target input information is intelligently recommended on the display interface in real time, and this process requires no input information specially input by the user for the recommended application, which can ensure that a process of executing the first application by the user may not be interrupted, make function recommendation without breaking the current operating environment, and realize the non-sensory interaction, thereby enhancing the immersion of the user and improving operating efficiency and use experience of the user.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and easier to understand, the specific implementation methods of the present disclosure are listed below.

### BRIEF DESCRIPTION OF THE DRAWINGS

In order to provide a clearer explanation of the technical solutions in the embodiments of the present disclosure or related art, a brief introduction will be given below to the accompanying drawings required in the descriptions of the embodiments or related art. It is obvious that the accompanying drawings in the following description are some embodiments of the present disclosure. For those skilled in the art, other accompanying drawings can be obtained based on these drawings without creative labor.

FIG. 1 schematically shows a flow chart of a function recommendation method according to the present disclosure;

FIG. 2 schematically shows an example of handwriting trajectory points for performing a method according to the present disclosure;

FIG. 3 schematically shows an example of a handwriting trajectory point line graph for performing a method according to the present disclosure;

FIG. 4 schematically shows a display example of a second application with target control information being “countdown” for performing a method according to the present disclosure;

FIG. 5 schematically shows a display example of a second application with target control information being “progress” for performing a method according to the present disclosure;

FIG. 6 schematically shows an example of target function recommendation in a display interface for performing a method according to the present disclosure;

FIG. 7 schematically shows an example of prompt information and network setting icons for performing a method according to the present disclosure;

FIG. 8 schematically shows an example of a function recommendation minimization icon for performing a method according to the present disclosure;

FIG. 9 schematically shows a function recommendation apparatus for performing a method according to the present disclosure; and

FIG. 10 schematically shows a computing and processing device for performing a method according to the present disclosure.

### DETAILED DESCRIPTION

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. Based on the embodiments of the present disclosure, all other embodiments obtained by persons skilled in the art without creative labor fall within the scope of protection of the present disclosure.

In related art, when users run related applications, they usually need to interact with a terminal device by clicking instructions, and call applications currently needed by the users in the terminal device and functional modules of the applications to realize corresponding functions. However, a step in which multi-level functions are called by frequently clicking instructions (mouse clicking or touch screen clicking, etc.) of the user is cumbersome with poor user experience.

With rapid development of the terminal device, the applications required by the users can be displayed to the users through automatic function recommendation made by the terminal device. For example, the users can input detailed description of the currently required application in a voice manner by opening a pickup interface for the function recommendation, and the terminal device can generate and display applications that satisfy characteristics of the description to users based on the detailed description, which avoids frequent clicking interaction between the users and the terminal device.

However, the function recommendation made with voice control requires the user to input clear voice operation instructions in a specific interface so as to recommend a specific application or perform a specific function, and in some usage scenarios, the needs of the user to interrupt a current operation to perform voice input to realize function recommendation, thus making the user with less immersion and degrading user experience. Even the user may abandon using this function recommendation in order not to break a current operating environment.

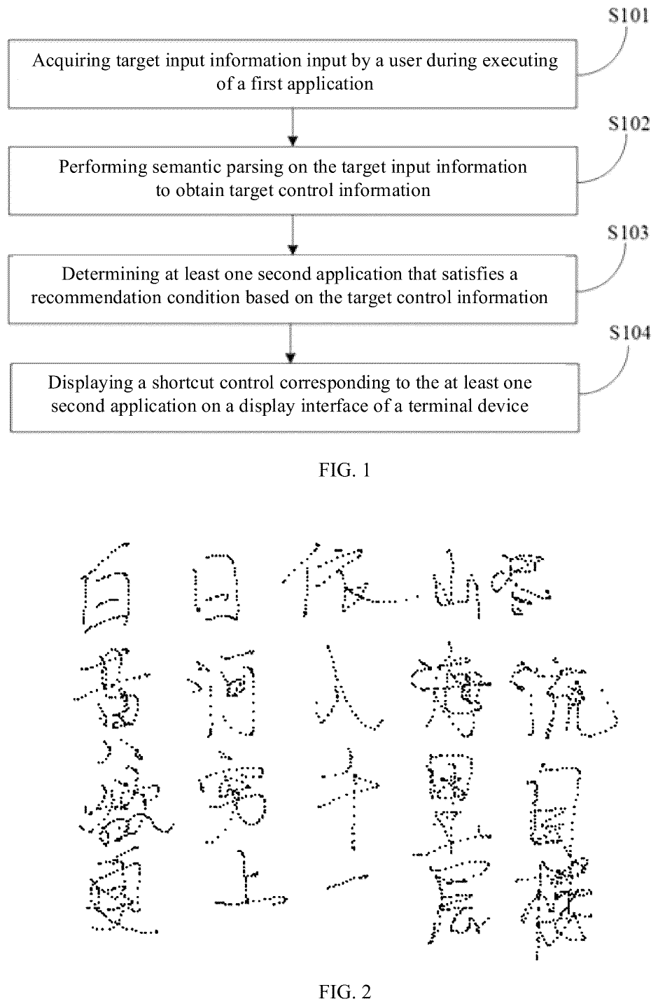

In view of this, a function recommendation method is provided in an embodiment of the present disclosure, and FIG. 1 schematically shows a flow chart of a function recommendation method according to the present disclosure, as shown in FIG. 1, the method includes following steps.

Step S101, acquiring target input information input by a user during executing of a first application.

The target input information input by the user is acquired during executing of the first application. The first application includes at least one of: a home application and a third-party application.

Step S102, performing semantic parsing on the target input information to obtain target control information.

Step S103, determining at least one second application that satisfies a recommendation condition based on the target control information.

Step S104, displaying a shortcut control corresponding to the at least one second application on a display interface of a terminal device.

In the embodiment of the present disclosure, the function recommendation method is applied to the terminal device, and the terminal device includes a plurality of applications. The first application is an application that can acquire the target input information of the user, and the first application at least includes a local home application (such as an application for displaying a homepage of the terminal device or the like) of the terminal device and a third-party application. The target input information contains the target control information intended by the user, the function recommendation for the target control information can be realized by performing a function of the second application in the terminal device. Specifically, the first application is an application that the user is executing. The first application can acquire an information source and generate corresponding text information as the target input information through an information acquisition unit of the terminal device, and the information acquisition unit can be a functional unit of the terminal device itself. For example, when the terminal device is a mobile terminal, the information acquisition unit can be a touch screen or a built-in camera of the mobile terminal; or the information acquisition unit can also be an external acquisition device that is established with wired connection or wireless connection with the terminal device. For example, the information acquisition unit can be a handwriting instrument that is established with wired connection with the terminal device or an external camera that is established with wireless connection with the terminal device.

When the needs of the user to use the second application during the executing of the first application, directly calling the second application or specially inputting voice description information for calling the second application through a voice pickup interface may interrupt a process of using the first application and reduce use immersion of the user. In the embodiment of the present disclosure, by directly processing the target input information when the user executes the first application, the second application needed by the user is intelligently acquired and recommended to the user, which can realize the function recommendation for the target control information of the user without breaking the current use environment of the user, thus improving the use experience of the user.

In the embodiment of the present disclosure, the target input information is text information corresponding to information that the terminal device can acquire through a local unit or an external device. For example, the target input information can be text information corresponding to information source in a form of voice information, handwriting trajectory point information, video information, text information, etc. It should be noted that the form of the information source of the target input information can be specifically determined according to actual situation, which is not limited in the present disclosure.

In the embodiment of the present disclosure, the semantic parsing is used to intelligently identify semantics of the target input information based on the target input information input by the user, and to generate the target control information that can represent needs of the user in the target input information based on the semantics of the target input information. The target control information is used to represent the needs of the user contained in the target input information. For example, for the target input information “Examination time is 100 minutes”, corresponding target control information is “countdown”; and for the target input information “calculate the average value”, corresponding target control information is “calculation”. The second application recommended to the user is determined by the target control information corresponding to the target input information, there is no need to acquire input information for the second application, and an application currently needed by the user is recommended to the user without the user's sensation, so that use experience of the user can be improved to maximum.

For example, the first application is a video conference. During executing of the video conference, the user inputs a voice message “Examination time is 100 minutes”, and text message “Examination time is 100 minutes” corresponding to the voice message is used as the target input information, which contains the target control information “Countdown” of the user, and this target control information can be realized by a second application “Timer” of the terminal device. However, during the video conference of the user, this video conference process may be interrupted either by opening of the application “Timer” by a clicking operation or by opening a voice recommendation interface to specifically input the voice recommendation detailed description information “opening the timer”. In the embodiment of the present disclosure, after the text information “Examination Time is 100 Minutes” corresponding to the voice information input by the user during the executing of an application “video conference” is acquired, the semantic parsing is performed on the text information to obtain the target control information “Countdown”, and the application “Timer” is automatically displayed on the display interface based on the target control information without interrupting the video conference process, so as to provide the currently needed timer application for the user in real time. It should be noted that the above example is only an optional case proposed for better understanding of the present disclosure by those skilled in the art, and other first applications and second applications can be used by those skilled in the art in the function recommendation method of the present disclosure without creative effort.

In order to make those skilled in the art better understand technical solutions of the embodiment of the present disclosure, the function recommendation method provided in the embodiment of the present disclosure is described in detail.

In a specific implementation of the step S101, the information acquisition unit of the terminal device acquires the target input information for the first application input by the user during the executing of the first application. Firstly, the information acquisition unit acquires original information input during the executing of the first application, and the first application controls the information acquisition unit to acquire the original information in an information form corresponding to the first application according to its own processing capacity and requirements. For example, when the first application is the “voice conference”, the original information is voice information or audio information; and when the first application is “handwriting input method”, the original information is handwriting trajectory point information. Because an information form of the original information may be different, it is necessary to unify original information in different information forms into text information for the semantic parsing. Therefore, after acquiring the original information input by the user during the executing of the first application, character recognition is performed on the original information to obtain the text information as the target input information.

In an optional implementation, when the first application is a handwriting application and the original information is the handwriting trajectory point information, the target input information corresponding to the handwriting trajectory point information is acquired according to a following process. Firstly, the handwriting trajectory point information input by the user is acquired, and FIG. 2 schematically shows an example of handwriting trajectory points for executing the method according to the present disclosure. As shown in FIG. 2, during the executing of the first application, the user inputs the handwriting trajectory point information through a handwriting device, and the handwriting trajectory point information is composed of a trajectory point diagram drawn by a user on the handwriting device in time sequence, that is, composed of a plurality of handwriting trajectory points, and the handwriting trajectory point information includes at least one of following items: coordinate values of trajectory points, timestamps of the trajectory points, and states of the trajectory points (pen down or pen up).

When the user inputs the handwriting trajectory point information, input timestamps of respective handwriting trajectory points are in a sequence, that is, the handwriting trajectory point information contains time information, but there is a case of inputting not in a normal stroke order when the user inputs the handwriting trajectory point information, that is, phenomenon of “writing with reverse or inserted strokes”. When the handwriting trajectory point information involves the phenomenon of “writing with reverse or inserted strokes”, the time information of the handwriting trajectory point information becomes a negative feature for a process of acquiring corresponding text information, which resulting in decrease in accuracy of the text information directly obtained based on the handwritten track point information.

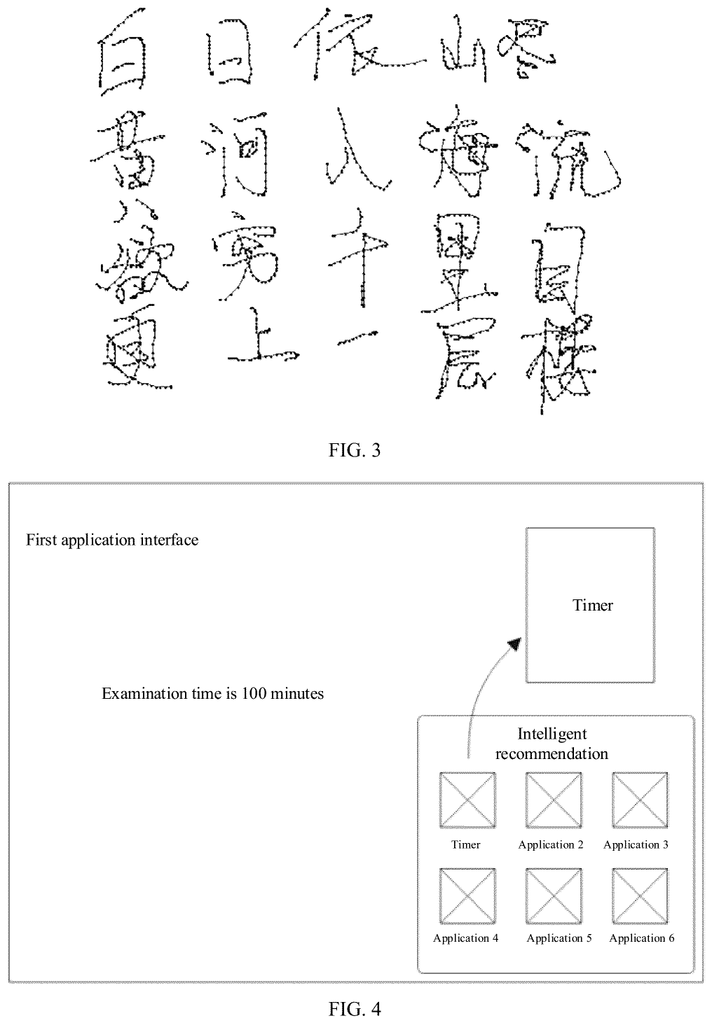

Therefore, in order to avoid negative influence caused by a time feature of the handwriting trajectory point information, the trajectory points in the handwriting trajectory point information are connected in line to remove the time information in the handwriting trajectory point information to obtain a handwriting trajectory line graph without the time feature. FIG. 3 schematically shows an example of the handwriting trajectory point line graph for performing the method according to the present disclosure. As shown in FIG. 3, the handwriting trajectory points in FIG. 2 are connected in line to obtain the handwriting trajectory point line graph. Because respective handwriting trajectory points are connected in line to form a character as a whole and time information of each handwriting trajectory point is removed, the handwriting trajectory point line graph is used as the original information without the time information, which can reduce a problem that the accuracy is reduced only with the handwriting trajectory point information as the original information for character recognition.

Then, the handwriting trajectory point information and the handwriting trajectory point line graph are input into a character recognition network. The character recognition network includes a first branch and a second branch. Specifically, the handwriting trajectory point information is input into the first branch of the character recognition network as first original information, and feature extraction and character recognition are performed on the handwriting trajectory point information (the coordinate values of the trajectory points, the timestamps of the trajectory points, and the states of the trajectory points) based on the first branch to obtain a first input feature, and the first input feature includes time information of the trajectory points of the handwriting trajectory point information. The handwriting trajectory line graph is input into the second branch of the character recognition network as second original information, and feature extraction and character recognition are performed on the handwriting trajectory line graph based on the second branch to obtain a second input feature, and the second input feature does not include the time information of the trajectory points of the handwriting trajectory point information. Finally, the first input feature and the second input feature are combined to obtain combined text information as the handwriting input information (that is, the target input information when the first application is the handwriting application). According to the embodiment of the present disclosure, the first input feature with the time information is acquired through the first branch and the second input feature without the time information is acquired through the second branch, so that negative influence caused by the time information as an output character recognition result is reduced, and after combination, the text information with high accuracy can be obtained, which represents character meaning of the input handwriting trajectory points, and this text information is used as the handwritten input information for a subsequent semantic recognition process. After the semantic parsing based on the handwritten input information, the at least one second application that satisfies the recommendation condition is determined, and a shortcut control corresponding to the second application is displayed on the application interface of the handwritten application. For specific semantic parsing and a process of determining the second application, subsequent specific implementation process of steps S102 to S103 can be referred.

For example, the first branch of the character recognition network is of an RNN network structure, which includes a combined architecture of a plurality of bi-directional long short term memory network (BiLSTM) layers and dropout layers which are arranged in sequence and a fully connected layer, the feature extraction is performed on the first original information by the plurality of BiLSTM layers, and the dropout layer is arranged behind each of the BILSTM layers to improve model recognition rate, and finally the first input feature is obtained through the fully connected layer. The second branch of the character recognition network is of a CNN network structure, which includes a plurality of down-sampling layers and a fully connected layer, and the feature extraction is performed on the second original information by the plurality of down-sampling layers, and the second input feature is obtained through the fully connected layer, and finally the first input feature and the second input feature are combined to obtain the text information corresponding to the original information. It should be noted that the above example is only an alternative implementation to make the skilled in the art better understand the solutions of the present disclosure. The character recognition network can be specifically determined according to actual situation, which is not limited in the present disclosure.

In an optional implementation, when the original information is voice information, the target input information corresponding to the voice information is obtained according to a following process. Firstly, the voice information input by the user based on an audio acquisition device connected with the terminal device is acquired; then, feature extraction is performed on the voice information to extract a part of a voice signal that is helpful for understanding language content and remove a part of the voice signal that is not helpful for understanding the voice content, and the voice information is converted into corresponding voice features, the voice features are decoded based on a voice recognition model, feature enhancing is performed on the voice features, which are then represented with text to obtain the text information corresponding to the voice information, and the text information is taken as the voice input information (that is, the target input information when the first application is a voice application).

For example, Mel-scale frequency cepstral coefficients (short for MFCC) feature extraction is performed on the voice information to obtain MFCC features corresponding to voice information; then, the MFCC features are input into a decoder such as an acoustic model (a traditional acoustic model GMM+HMM), a pronunciation dictionary and a language model to decode the voice features, and feature enhancing is performed on the voice features, which are then represented with the text to obtain the text information corresponding to the voice information, and the text information is taken as the target input information. It should be noted that the above example is only an alternative implementation to make the persons skilled in the art better understand the solutions of the present disclosure. The speech recognition model can be specifically determined according to actual situation, such as traditional acoustic model (dynamic time warping, hidden Markov model, etc.), deep learning algorithm based on an artificial neural network (such as a Time Delay Neural Network TDNN, a Transformer model based on convolution enhancement), etc., which is not limited in the present disclosure.

In a specific implementation of the step S102, after the target input information in a form of text information is acquired, the semantic parsing is performed based on the target input information to obtain the target control information represented by the target input information, and the target control information exhibits the demand of the user in inputting the target input information.

In an optional implementation, the target control information corresponding to the target input information is obtained by matching with the candidate control information. Because the target input information is the text information corresponding to the original information collected in a target time of period, it contains at least one clause, and target control information corresponding to each of the at least one clause may be different. For example, if the target input information is “A project will be reported on September 15th, and additionally a certain item needs to be voted”, the target input information includes two clauses “A project will be reported on September 15th” and “additionally a certain item needs to be voted”, in which target control information of the former and latter clauses is different, a user demand for the former clause is “schedule” and an user demand of the latter clause is “voting”, and thus it is necessary to perform sentence splitting on the target input information so as to accurately obtain the target control information for the target input information, and then semantic parsing is performed on each clause.

Specifically, firstly, the sentence splitting is performed on the target input information to obtain the at least one clause, and then word segmentation is performed on each of the at least one clause corresponding to the target input information to obtain a plurality of segmented words. Because each of the at least one clause is composed of multiple segmented words, meanings of the segmented words are easier to be parsed semantically than a whole clause, and the target control information of the user can also be represented by the segmented words, and thus the word segmentation is performed on each of the at least one clause to obtain the plurality of segmented words. A group of candidate control information is preset in the terminal device, and the candidate control information is a segmented word corresponding to each application cluster. All of applications in the terminal device are grouped according to functional types of the applications to obtain at least one application cluster, and all of applications in each application cluster correspond to a segmented word of a same functional type, and this segmented word (i.e., the functional type corresponding to each application cluster) is taken as a piece of candidate control information. Each segmented word in the target input information is matched with the candidate control information to obtain a second matching degree, which represents coincidence degree of each segmented word with each candidate control information. The greater the second matching degree, the more similar the segmented word is to the candidate control information, and the greater possibility that the segmented word represents the target control information of a corresponding clause. Contrariwise, the smaller the second matching degree, the greater the difference between the segmented word and the candidate control information, and the smaller the possibility that the segmented word represents the target control information of the corresponding clause. After the second matching degrees between each segmented word and all of the candidate control information are obtained, candidate control information with a second matching degree greater than a second matching threshold is taken as the target control information of a clause to which the segmented word belongs. In addition, if the second matching degrees between the segmented word and all of the candidate control information are all less than the second matching threshold, it indicates that the segmented word cannot be used as the target control information of the clause. It should be noted that the second matching threshold and the candidate control information can be determined according to actual situation, which is not limited in the present disclosure.

For example, the segmented word is “voting” and first candidate control information is “video playing”, an application cluster corresponding to the first candidate control information contains a variety of applications that can play video. After matching, it is found that the second matching degree between the segmented word and the first candidate control information is far less than the second matching threshold, and thus the segmented word fails to match the first candidate control information. Second candidate control information is “voting”, and an application cluster corresponding to the second candidate control information contains a variety of voter applications. After matching, it is found that the second matching degree between the segmented word and the second candidate control information is greater than the second matching threshold, then the segmented word is successfully matched with the first candidate control information, and the second candidate control information is used as the target control information of the clause.

In another optional implementation, the target control information corresponding to the target input information is acquired through a classification model. Firstly, sentence splitting and word segmentation are performed on the target input information, to obtain multiple segmented word corresponding to each clause. Because there is a sequence for respective segmented words in the clause, sequence information of the segmented words is captured when semantic features of the clause are acquired, so classification input data including the sequence for the segmented words is constructed firstly. Specifically, a left segmented word and a right segmented word corresponding to each segmented word in the clause are used as the classification input data to obtain a classification input data set. The classification input data set is input into the classification model, and semantic parsing is performed on the classification input data set based on the classification model to acquire the target control information. In the embodiment of the present disclosure, sequence feature information of the segmented words is captured, and the target control information is obtained by using each segmented word and its preceding word (left segmented word) and succeeding word (right segmented word) as input data, thus improving accuracy of the target control information. It should be noted that the classification model selected in the embodiment of the present disclosure can be determined according to actual situation, for example, the classification model can be a common text classification model such as a random forest model (RF), a SVM classification model, and a TextCNN classification model, which is not limited in the present disclosure.

In a specific implementation of the step S103, because the first application is an application that the terminal device is executing, the first application does not need to be opened by the function recommendation method according to the present disclosure, and thus the first application is excluded from applications that need to be recommended in order to reduce recommendation delay of the function recommendation method according to the present disclosure. Firstly, the target control information is matched with a plurality of applications in the terminal device to obtain first matching degrees. For example, the target control information is matched with names of the plurality of applications in the terminal device, and coincidence degree between the target control information and names of the applications is obtained as a first matching degree. The first matching degree represents coincidence degree between the target control information and an application. The greater the first matching degree, the more similar a name of an application is to the target control information, and the greater possibility that the application is an application that executes the target control information. Contrariwise, the smaller the first matching degree, the greater the difference between the name of the application and the target control information, and the smaller the possibility that the application is an application that executes the target control information. It should be noted that the above example is only an alternative implementation to make the skilled in the art better understand the solutions of the present disclosure. A method of acquiring the first matching degree can be specifically determined according to actual situation, and for example, the first matching degree can be coincidence degree between the target control information and a name of the application, function type or other information, which is not limited in the present disclosure.

After the first matching degrees between the target control information and the plurality of applications in the terminal device are obtained, the second application that satisfies the recommendation condition is acquired based on the first matching degrees. The recommendation condition can be that the first matching degree is greater than a first matching threshold, or can be in other matching manners. It should be noted that the first recommendation threshold can be determined according to actual situation, which is not limited in the present disclosure.

In an optional implementation, when the target control information is acquired in an allocation manner, and the candidate control information whose second matching degree with the target control information is greater than the second matching threshold has been determined in a process of acquiring the target control information, it is not necessary to match with the plurality of applications in the terminal device, and it only needs to acquire the target control information to match with applications in an application cluster corresponding to the candidate control information to obtain the first matching degrees. Because the second matching degree between the candidate control information and the segmented word is greater than the second matching threshold, it indicates that the applications in the application cluster corresponding to the candidate control information have high coincidence degree. At this time, only the applications in the application cluster needs to be matched again with the first matching threshold to determine the second application, which can greatly reduce matching time and improve recommendation accuracy.

For example, if a second matching degree between a segmented word in a clause in the target input information and the candidate control information is greater than the second matching threshold of 60%, the candidate control information is regarded as target control information corresponding to the clause. The application cluster corresponding to the candidate control information contains a plurality of applications, and the target control information is matched with all of the applications in the application cluster, and an application with a first matching degree greater than the first matching threshold of 80% is acquired as the second application that satisfies the recommendation condition.

In a specific implementation of the step S104, the application is displayed as a shortcut control corresponding to the second application on the display interface of the terminal device. The shortcut control corresponding to the second application can be an icon or a link corresponding to a startup control of the second application, and the shortcut control corresponding to the second application is displayed in a target area on the display interface, and this target area can be around or inside a display area of a function interface of the first application on the display interface when the user executes the first application. It should be noted that the display area of the second application on the display interface of the terminal device can be determined according to actual situation, which is not limited in the present disclosure.

In an optional implementation, after the target control information is matched with the plurality of applications in the terminal device, there may be a plurality of applications that satisfy the recommendation condition. At this time, all of the applications that satisfy the recommendation conditions (with the first matching degrees greater than the first matching threshold) are regarded as candidate second applications, and there is high possibility that these candidate second applications can satisfy the requirements of the user and execute the target control information, and thus the candidate second applications are sorted according to the first matching degrees corresponding to the candidate second applications, and shortcut controls corresponding to the candidate second applications are sequentially displayed on the display interface of the terminal device in a descending order of the first matching degrees of the candidate second applications.

For example, FIG. 4 schematically shows a display example of a second application with target control information of “Countdown” for performing the method according to the present disclosure. As shown in FIG. 4, the target input information is “Examination time is 100 minutes”, and the target control information corresponding to the target input information obtained through the semantic parsing is “Countdown”. Based on the target control information “Countdown”, the second application “Timer” and other second applications “application 2”, “Application 3”, . . . , “application 6” with first matching degrees with the target control information “Countdown” greater than the first matching threshold are acquired, with their first matching degrees decreased sequentially. Application icons of the second application “Timer” and the other second applications “Application 2”, “Application 3”, . . . , “Application 6” are sequentially displayed on the display interface of the terminal device. The user can directly open the second application “Timer” by clicking a “Timer” icon on the display interface during executing of the first application.

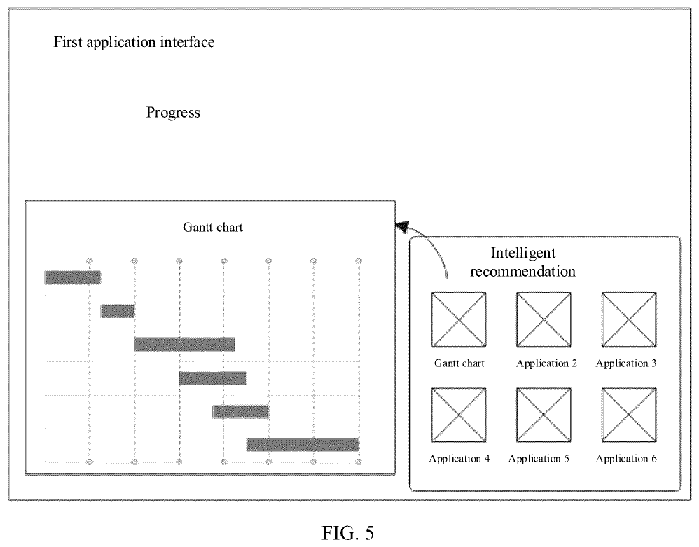

For example, FIG. 5 schematically shows a display example of a second application with target control information of “Progress” for performing the method according to the present disclosure. As shown in FIG. 5, the target input information is “Progress”, and the target control information corresponding to the target input information obtained through the semantic parsing is “progress”. Based on the target control information “Progress”, the second application “Gantt chart” and other second applications “Application 2”, “Application 3”, . . . , “Application 6” with first matching degrees with the target control information “Progress” greater than the first matching threshold are acquired, with their first matching degrees decreased sequentially. Application icons of the second application “Gantt chart” and the other second applications “Application 2”, “Application 3”, . . . , “Application 6” are sequentially displayed on the display interface of the terminal device. The user can directly open a functional interface of the Gantt Chart application by clicking a “Gantt Chart” icon on the display interface during executing of the first application.

It should be noted that the above examples are specific implementation examples given to make the skilled in the art better understand the solutions of the present disclosure, and the second application can be specifically determined according to different target control information, such as a smart chart, a smart formula, a SWOT chart, a pyramid chart, a KANO model and other applications, which is not limited in the present disclosure.

In an optional implementation, after the second application for the target input information is displayed on the display interface of the terminal device, the user can operate on a first shortcut control by interacting with the terminal device during executing of the first application to input the target input information, so as to open the second application for the target input information. The terminal device opens an application interface of the second application for the target input information on the display interface in response to an operation on the first shortcut control. Then, the user inputs the first configuration information for controlling the second application to execute the target control information, and the terminal device receives the first configuration information input by the user and switches the application interface of the second application to a functional interface for executing the first configuration information.

In an optional implementation, the target input information input by the user during executing of the first application includes first input information and second input information, and the second input information is information input after the first input information by the user during executing of the first application. After the first input information is input, the second input information is consecutively input, and the terminal device performs semantic parsing on the first input information to obtain the first target control information, and determines at least one second application for the first input information that satisfies the recommendation condition based on the first target control information. The terminal device performs semantic parsing on the second input information to obtain second target control information, and determines at least one second application for the second input information that satisfies the recommendation condition based on the second target control information. Specifically, a process of generating the second application for the first input information based on the first input information and a process of generating the second application for the second input information based on the second input information are the same as the above process of generating the second application for the target input information based on the target input information, which can be referred to steps S101 to S104 for details and is not be repeatedly described herein.

After the application interface of the second application for the first input information is displayed on the display interface of the terminal device in response to the operation of the user on the first shortcut control, when the second application for the second input information and the second application for the first input information are different applications, the user can operate on a second shortcut control by interacting with the terminal device during executing of the first application to input the second input information, and the terminal device opens the second application for the second input information in response to the operation of the user on the second shortcut control. In response to the operation of the user on the second shortcut control, the terminal device closes the second application for the first input information and opens the second application for the second input information on the display interface, thus completing switching from executing the target control information corresponding to the first input information to executing the target control information corresponding to the second input information.

In an optional implementation, after the user opens the second application recommended by the display interface, it still needs to input the first configuration information in the application interface of the second application for function setting, which may still break the current usage environment of the user to some extent. In order to further improve the experience of the user, after the second application that satisfies the recommendation condition is determined, the second configuration information of the user can be directly determined through the target input information, and the target function can be automatically generated and recommended to the user through the second information, thus preventing the user from manually inputting the configuration information (that is, the first configuration information). Specifically, firstly, configuration information identification is performed on the target input information input by the user during the executing of the first application to obtain the second configuration information, and the second configuration information is an entity segmented word with a specific meaning in the target input information (text information), and for example, the second configuration information can be a segmented word of a person's name, a place name, an organization name, a proper name, a numerical value, an unit or the like in the target input information, and the second configuration information represents a specific standard or an execution object in executing the target control information. In the embodiment of the present disclosure, a method for identifying configuration information of the target input information can be specifically determined according to actual situation, and for example, common identification algorithms such as conditional random field (CRF), LSTM+CRF, BERT+LSTM+CRF can be adopted, which is not limited in the present disclosure.

Then, the second applications that satisfy the recommendation condition are acquired, of which a detailed process can be referred to description of the steps S101 to S104 above. The second applications are filtered to obtain a second application that can execute the target control information according to entity information as a target application that can execute the entity information. Because there can be multiple second applications that satisfy the recommendation condition, some of them cannot perform functions according to the entity information, which should be filtered and removed, and the target application that can perform the functions according to the entity information are kept. After the target application is obtained, the terminal device determines the target function, and the target function is to control the target application to execute instructions corresponding to the target control information, and the target function is set based on the second configuration information. With this target function, the user can directly execute the target application according to the entity information, without additional function setting. In this way, the user experience is improved and the immersion of the user is increased. Finally, a shortcut control corresponding to the target function is generated, and the shortcut control corresponding to the target function is displayed on the display interface of the terminal device.

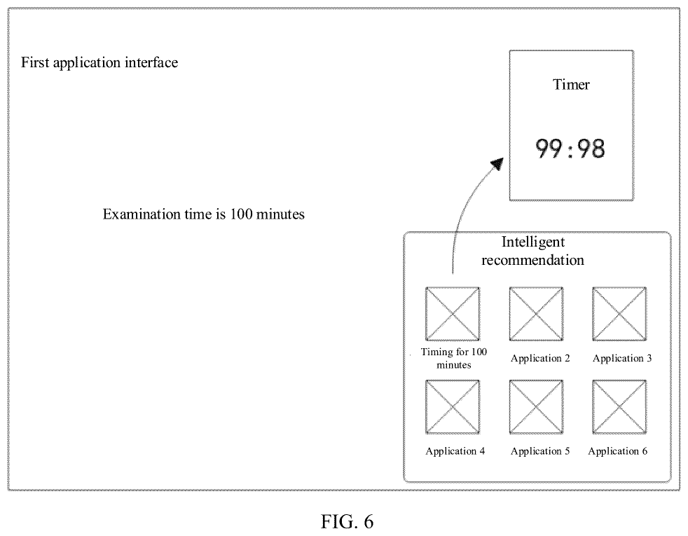

For example, the target application (the second application that can execute the target control information according to the second configuration information) is a countdown application. FIG. 6 schematically shows an example of target function recommendation in the display interface for performing the method according to the present disclosure. As shown in FIG. 6, the target input information is “Examination time is 100 minutes”, and the target control information corresponding to the target input information obtained by the semantic parsing is “Countdown”, and two second applications “Timer” and “Stopwatch” that satisfy the recommendation condition are obtained. The second configuration information obtained by performing the configuration information identification on the target input information is “100 minutes”. Two second applications “Timer” and “Stopwatch” are filtered, and it is determined that the application “Timer” can perform a countdown operation according to a specific setting of “100 minutes”, but the application “Stopwatch” cannot perform the countdown operation according to the specific setting of “100 minutes”, and thus the application “Timer” is taken as a target application, a target function of “Timing for 100 minutes” can be generated, and a target function icon of the target function of “Timing for 100 minutes” is displayed on the display interface of the terminal device. During the executing of the first application, the user can directly start the timer to count down for 100 minutes by clicking the target function icon of the target function of “Timing for 100 minutes” on the display interface.

In an optional implementation, after the target function for the target input information is displayed on the display interface of the terminal device, the user can operate on a third shortcut control by interacting with the terminal device during the executing of the first application to input the target input information, so as to open the target application and execute the target function for the target input information. In response to the operation of the user on the third shortcut control, the terminal device opens the target function interface of the target application on the display interface and performs the target function for the target input information.

In an optional implementation, the target input information includes third input information, and in order to further improve the experience of the user, configuration information identification is performed on the third input information after the second application that satisfies the recommendation condition is determined based on the third input information, so as to obtain the second configuration information. The user operates on the first shortcut control to open the second application for the third input information. The terminal device opens the application interface of the second application for the target input information on the display interface in response to the user's operation on the first shortcut control, and configures the second application based on the second configuration information, so that the application interface of the second application is switched to a functional interface for executing the second configuration information.

For example, the second application for the third input information is a countdown application, the third input information is “Examination time is 10 minutes”, and target control information corresponding to the third input information obtained by the semantic parsing is “Countdown”, and the countdown application “Timer” that satisfies the recommendation condition is acquired. The second configuration information obtained by performing configuration information identification of the third input information is “10 minutes”. The user operates on the first shortcut control, and the terminal device opens an application interface of the application “Timer” in response to the user's operation on the first shortcut control, and automatically switches a display interface of the countdown application “Timer” to a functional interface of “Counting down for 10 minutes” based on the second configuration information of “10 minutes”.

Since the input target input information includes the first input information and the second input information, the user consecutively inputs the second input information after inputting the first input information during the executing of the first application, and the terminal device generates a second target function for the second input information based on the second input information. Specifically, a process of generating the second target function based on the second input information is the same as the above process of generating the target function for the target input information based on the target input information, which is not be repeatedly described herein. After the second target function is displayed on the display interface of the terminal device, it is determined whether an application corresponding to the second target function is the same as an application corresponding to the target function.

When an application corresponding to the second target function for the second input information is the target application, it indicates that the target function and the second target function can be performed by a same target application. During the executing of the first application to input the second input information, the user operates on a fourth shortcut control to control performing of the second target function by interacting with the terminal device. In response to the operation of the user on the fourth shortcut control, the terminal device switches the target application to a second target function interface and performs the second target function.

When the application corresponding to the second target function for the second input information is different from the target application, it indicates that the target function and the second target function need to be performed by different applications. During the executing of the first application to input the second input information, the user operates on the fourth shortcut control by interacting with the terminal device. The target application is closed in response to the operation of the user on the fourth shortcut control, and the second target application for the second input information is opened on the display interface to perform the second target function.

In an optional implementation, the user consecutively inputs the second input information after inputting the first input information during the executing of the first application, and the terminal device generates the second application for the second input information based on the second input information. Because the user consecutively inputs the first input information and the second input information during the executing of the first application, the second application for the first input information is displayed on the display interface during inputting of the first input information, and the second application for the second input information is displayed on the display interface during inputting of the second input information. When an input interval between the first input information and the second input information is small, an executable time of period in which the user operates on the shortcut control to control execution of the second application for the first input information is short, which affects the user's use experience to a certain extent.

After the second application for the second input information is acquired, a shortcut control corresponding to the second application for the first input information is retained on the display interface of the terminal device. Specifically, the shortcut control corresponding to the second application for the second input information is placed in front of the shortcut control corresponding to the second application for the first input information, and the shortcut control corresponding to the second application for the second input information and the shortcut control corresponding to the second application for the first input information are simultaneously displayed on the display interface of the terminal device. Preferably, considering limitation of a number of shortcut controls corresponding to displayable applications on the display interface, a preset number of shortcut controls corresponding to the second applications for the first input information are reserved and displayed on the display interface according to a sequence of the first matching degrees of the second applications, and the shortcut control corresponding to the second application for the second input information and the preset number of the shortcut controls corresponding to the second applications for the first input information are sequentially displayed on the display interface of the terminal device. For example, all of shortcut controls corresponding to the second applications for the second input information are displayed on the display interface, and one shortcut control corresponding to the second application for the first input information is reserved behind the second application for the second input information. It should be noted that the above example is only an alternative implementation to make the skilled in the art better understand the solutions of the present disclosure, and the preset number can be determined according to actual situation, which is not limited in the present disclosure.

In an optional implementation, the second application is a local application of the terminal device, and the terminal device includes a cloud platform application executed through a network in addition to the first application and the second application. In the present disclosure, the third application can be determined and recommended to the user based on matching of the target control information with the cloud platform application. Specifically, after the second application that satisfies the recommendation condition is determined, a network state of the terminal device is determined, and the network state includes a network connection state and a non-network connection state, and the network connection can be wired connection or wireless connection. When the terminal device is in the network connection state, a first matching degree between the target control information and the cloud platform application is determined based on the target control information corresponding to the target input information, and when the first matching degree between the target control information and the cloud platform application is greater than the first matching threshold, the cloud platform application that satisfies the recommendation condition is determined as the third application. Finally, the shortcut control corresponding to the second application and the shortcut control corresponding to the third application are simultaneously displayed on the display interface of the terminal device.

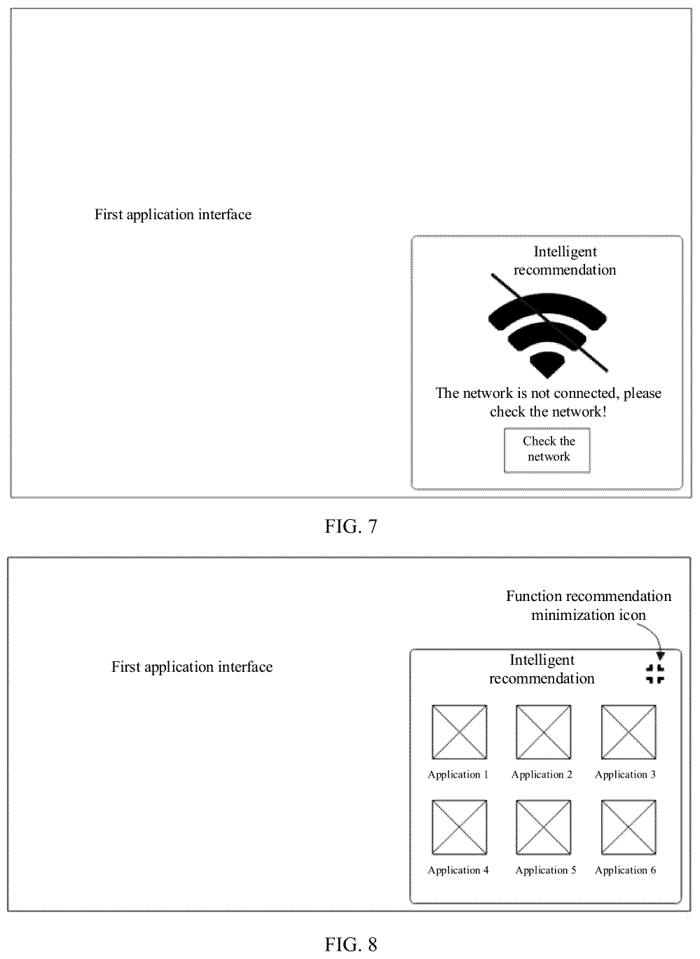

When the terminal device is in the non-network connection state, prompt information is displayed on the display interface of the terminal device, and the prompt information is used for prompting the user to check the network state of the terminal device. FIG. 7 schematically shows an example of prompt information and network setting icons for performing the method according to the present disclosure. As shown in FIG. 7, prompt message (“The network is not connected, please check the network!” in FIG. 7) is displayed on the display interface, and at the same time, a network setting icon (“Check the network” in FIG. 7) is generated on the display interface of the terminal device, and the network device icon is configured for jumping to a network setting interface of the terminal device in response to the instructions of the user (such as a click operation). When the user interacts with the network setting icon, the network setting interface is displayed on the display interface of the terminal device in response to an interactive operation between the user and the network setting icon.

In an optional implementation, a function recommendation minimization icon is configured on the display interface of the terminal device. FIG. 8 schematically shows an example of a function recommendation minimization icon for performing the method according to the present disclosure. As shown in FIG. 8, during the executing of the first application, the user controls the display interface of the terminal device to minimize a function recommendation area by an interactive operation with the function recommendation minimization icon on the display interface. An extended icon is configured in the minimized function recommendation area, and the user controls the display interface of the terminal device to restore the function recommendation area to a normal display mode by an interactive operation with the extended icon in the minimized function recommendation area.

A function recommendation method is provided in the embodiments of the present disclosure. The function recommendation method includes: acquiring the target input information input by the user during executing of the first application, the first application includes at least one of: a home application and a third-party application; performing the semantic parsing on the target input information to obtain the target control information; determining the at least one second application that satisfies the recommendation condition based on the target control information; and displaying the shortcut control corresponding to the at least one second application on the display interface of the terminal device.

According to the embodiment of the present disclosure, the target control information is determined for the target input information during executing of the first application by the user and a related application corresponding to the target input information is intelligently recommended on the display interface in real time, and this process requires no input information specially input by the user for the recommended application, which can ensure that a process of executing the first application by the user may not be interrupted, make function recommendation without breaking the current operating environment, and realize the non-sensory interaction, thereby enhancing the user's immersion and improving the user's operating efficiency and use experience.

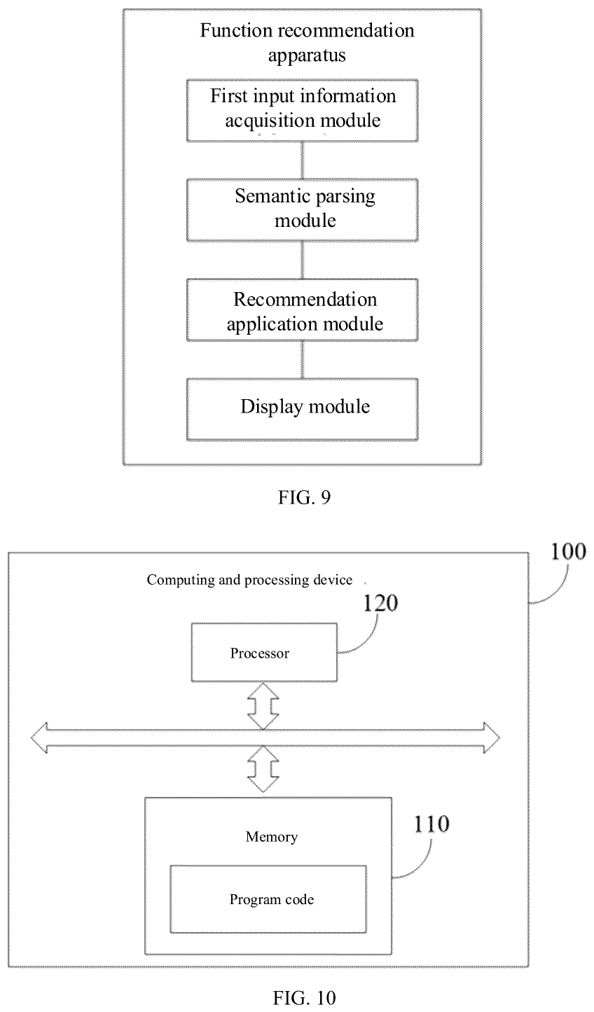

Based on a same inventive concept, a function recommendation apparatus is provided in an embodiment of the present disclosure, and FIG. 9 schematically shows a function recommendation apparatus for performing a method according to the present disclosure, as shown in FIG. 9, the apparatus includes:
a target input information acquisition module configured for acquiring target input information input by a user during executing of a first application;
a semantic parsing module configured for performing semantic parsing on the target input information to obtain target control information;
a recommendation application module configured for determining a second application that satisfies a recommendation condition based on the target control information; and
a display module configured for displaying a shortcut control corresponding to the second application on a display interface of a terminal device.

In an optional implementation, the apparatus further includes:
an application opening module for opening an application interface of the second application in response to an operation of the user on a first shortcut control; and
an interface switching module configured for receiving first configuration information input by the user and switching the application interface of the at least one second application to a functional interface for executing the first configuration information.

In an optional implementation, the apparatus further includes:
a configuration information acquisition module configured for performing configuration information identification on the target input information to obtain second configuration information;
a target application module configured for determining a target application based on the second application and the second configuration information, the target application being a second application capable of executing the target control information according to the second configuration information;
a target function module configured for determining a target function, the target function being to control the target application to execute instructions corresponding to the target control information, and the target function being set based on the second configuration information; and
a second display module configured for displaying a shortcut control corresponding to the target function on the display interface of the terminal device.

In an optional implementation, the apparatus further includes:
a configuration acquisition module configured for performing configuration information identification on third input information to obtain second configuration information;
an opening module for opening an application interface of the second application in response to an operation of the user on a first shortcut control; and
an application configuration module configured for configuring the second application based on the second configuration information, so as to switch the application interface of the second application to a functional interface for executing the second configuration information.

In an optional implementation, the semantic parsing module includes:
a first parsing submodule configured for performing the semantic parsing on the first input information to obtain first target control information; and
a second parsing the submodule configured for performing semantic parsing on the second input information to obtain second target control information.

The recommendation application module includes:
a first recommendation application submodule configured for determining at least one second application for the first input information that satisfies the recommendation condition based on the first target control information; and
a second recommendation application submodule configured for determining at least one second application for the second input information that satisfies the recommendation condition based on the second target control information.

The display module includes:
a third display submodule configured for displaying a shortcut control corresponding to the second application for the second input information and a shortcut control corresponding to the second application for the first input information on the display interface of the terminal device at the same time.

In an optional implementation, the display module includes:
a first control submodule configured for opening an application interface of the second application for the first input information on the display interface in response to an operation of the user on the first shortcut control; and
a second control submodule configured for closing the application interface of the second application for the first input information and opening an application interface of the at least one second application for the second input information on the display interface, in response to an operation of the user on the second shortcut control.

In an optional implementation, the apparatus further includes:
a network recommendation application module configured for determining a third application that satisfies the recommendation condition based on the target control information when the terminal device is in a network connection state, the third application being a cloud platform application; and
a fourth display module configured for displaying the shortcut control corresponding to the second application and a shortcut control corresponding to the third application on the display interface of the terminal device at the same time.

In an optional implementation, the apparatus further includes:
a prompt module configured for displaying prompt information on the display interface of the terminal device when the terminal device is in a non-network connection state, the prompt information being used for prompting the user to check a network state of the terminal device;
a network setting display module configured for generating a network setting icon on the display interface of the terminal device; and
a fifth display module configured for displaying a network setting interface on the display interface of the terminal device in response to an interactive operation between the user and the network setting icon.

In an optional implementation, the recommendation application module includes:
a first matching submodule configured for matching the target control information with a plurality of applications in the terminal device to obtain first matching degrees; and
a recommendation application submodule configured for acquiring the at least one second application that satisfies the recommendation condition based on the first matching degrees.

In an optional implementation, the apparatus further includes:
a first matching module configured for matching the target control information with a plurality of applications in the terminal device to obtain first matching degrees; and
a candidate second application acquisition module configured for acquiring at least one candidate second application that satisfies the recommendation condition based on the first matching degrees, the recommendation condition being that a first matching degree is greater than a first matching threshold; and
a fifth display module configured for sequentially displaying a shortcut control corresponding to the at least one candidate second application on the display interface of the terminal device according to a sequence of the first matching degrees of the at least one candidate second application.

In an optional implementation, the apparatus further includes:
a handwriting input information acquisition module configured for acquiring the target input information input by the user during the executing of the first application, the first application being a handwriting application, the target input information being handwriting input information, and the handwriting input information being text information obtained by character recognition for
a second semantic parsing module configured for performing the semantic parsing on the handwriting input information to obtain the target control information;
a third recommendation application module configured for determining at least one of the second applications that satisfies the recommendation condition based on the target control information; and
a sixth display module configured for displaying the shortcut control corresponding to the at least one second application on the application interface of the handwriting application.

In an optional implementation, the handwriting input information acquisition module includes:
a handwriting information acquisition submodule configured for acquiring the handwriting trajectory point information input by the user, the handwriting trajectory point information including at least one of: coordinate values of trajectory points, timestamps of the trajectory points, and states of the trajectory points;
a line graph acquisition submodule configured for acquiring a handwriting trajectory line graph based on the handwriting trajectory point information;
a first input feature submodule configured for inputting the handwriting trajectory point information into a first branch of a character recognition network to obtain a first input feature, the first input feature including time information of the trajectory points of the handwriting trajectory point information;
a second input feature submodule configured for inputting the handwriting trajectory line graph into a second branch of the character recognition network to obtain a second input feature, the second input feature not including the time information of the trajectory points of the handwriting trajectory point information; and a combination submodule for combining the first input feature with the second input feature
to obtain the handwritten input information.

In an optional implementation, the target input information acquisition module further includes:
a voice information acquisition submodule configured for acquiring voice information input by the user;
a feature extraction submodule configured for performing feature extraction on the voice information to obtain voice features; and
a decoding submodule configured for decoding the voice features based on a voice recognition model to obtain the voice input information.

In an optional implementation, the semantic parsing module includes:
a sentence splitting submodule configured for acquiring at least one clause based on the target input information;
a word segmentation submodule configured for performing word segmentation on a clause in the target input information to obtain a plurality of segmented words;
a second matching submodule configured for matching each of the plurality of segmented words with candidate control information to obtain a second matching degree; and
a target control information acquisition submodule configured for taking candidate control information with a second matching degree greater than a second matching threshold as the target control information.

In an optional implementation, the second matching submodule includes:
an application acquisition subunit configured for acquiring all of applications in the terminal device, with tags for representing functional types of the applications in the terminal device;
an application clustering subunit configured for grouping all of the applications in the terminal device according to a functional type of each of the applications in the terminal device to obtain at least one application cluster, functional types of applications in each application cluster being the same; and
a candidate control information acquisition subunit configured for taking a function type corresponding to each application cluster as one of the candidate control information.

In an optional implementation, the semantic parsing module further includes:
a classification input data acquisition submodule configured for taking a left segmented word and a right segmented word corresponding to each segmented word in the clause as classification input data to obtain a classification input data set; and
a semantic parsing submodule configured for inputting the classification input data set into a classification model, performing semantic parsing on the classification input data set based on the classification model to acquire the target control information.

The device embodiments described above are only illustrative, where the units described as separate components may or may not be physically separated, and the components displayed as units may or may not be physical units, that is, they can be located in one place or distributed across multiple network units. Some or all modules can be selected according to actual needs to achieve the purpose of this embodiment. Persons skilled in the art can understand and implement it without creative labor.

Various component examples of the present disclosure may be implemented in hardware, or in a software module running on one or more processors, or in a combination thereof. Those skilled in the art will understand that a microprocessor or digital signal processor (DSP) may be used in practice for implementing some or all of the functions of some or all of the components in the computing and processing device according to the example of the present disclosure, the present disclosure may also be implemented as an apparatus or device program (for example, a computer program and a computer program product) for executing some or all of the methods described herein. Such a program implementing the present disclosure may be stored on the computer-readable medium, or may be in the form of one or more signals. Such signals may be downloaded from an Internet website, provided on a carrier signal, or provided in any other form.

For example, FIG. 10 shows the computing and processing device which may implement the method according to the present disclosure. The computing and processing device 100 conventionally includes a processor 120 and a computer program product or computer-readable medium in the form of a memory 110. The memory 110 may be an electronic memory such as a flash memory, an electrically erasable programmable read only memory (EEPROM), an EPROM, a hard disk, or an ROM. The memory 110 has a storage space for a program code for executing any method step in the method described above. For example, the storage space for the program code may include various program codes for implementing various steps in the above method, respectively. The program codes may be read from or written into one or more computer program products. These computer program products include a program code carrier such as a hard disk, a compact disc (CD), a storage card, or a floppy disk. Such a computer program product is generally a portable or fixed storage unit. The storage unit may have storage segments, storage space and the like arranged similarly to the memory 110 in the computing and processing device of FIG. 10. The program code may, for example, be compressed in a suitable form. Generally, the storage unit includes computer-readable codes, namely codes which may be read by, for example, a processor such as the processor 120, and these codes, when run by the computing and processing device, cause the computing and processing device to execute various steps in the method described above.

Reference herein to “one example”, “example”, or “one or more examples” means that a particular feature, structure, or characteristic described in connection with the examples is included in at least one example of the present disclosure. In addition, it is noted that instances of the word “in one example” herein are not necessarily all referring to the same example.

In the description provided herein, numerous specific details are set forth. However, it is understood that examples of the present disclosure may be practiced without these specific details. In some instances, well-known methods, structures and techniques have not been shown in detail in order not to obscure the understanding of this description.

In the claims, any reference signs placed between parentheses shall not be construed as limiting the claims. The word “comprising” does not exclude the presence of elements or steps other than those listed in the claims. The word “a” or “an” preceding an element does not exclude the presence of a plurality of such elements, the present disclosure may be implemented by means of hardware including a plurality of distinct elements, and by means of a suitably programmed computer. In the unit claims enumerating a plurality of devices, a plurality of devices in these devices may be specifically embodied by the same hardware item. The use of the words such as first, second, and third does not denote any order. These words may be interpreted as names.

Finally, it should be noted that the above examples are merely illustrative of the technical solutions of the present disclosure, and do not limit the same; although the present disclosure has been described in detail with reference to the foregoing examples, persons skilled in the art will understand that the technical solutions disclosed in various examples described above may still be modified, or some of the technical features thereof may be replaced with equivalents; however, these modifications or replacements do not enable the essence of the corresponding technical solutions to be depart from the spirit and scope of the technical solutions of various examples of the present disclosure.

1. A function recommendation method, comprising:
acquiring target input information input by a user during executing of a first application;
performing semantic parsing on the target input information to obtain target control information;
determining at least one second application that satisfies a recommendation condition based on the target control information; and
displaying a shortcut control corresponding to the at least one second application on a display interface of a terminal device.

2. The function recommendation method according to claim 1, wherein after displaying the shortcut control corresponding to the least second application on the display interface of the terminal device, the method further comprises:
opening an application interface of the at least one second application in response to an operation of the user on a first shortcut control; and
receiving first configuration information input by the user and switching the application interface of the at least one second application to a functional interface for executing the first configuration information.

3. The function recommendation method according to claim 1, wherein after determining the at least one second application that satisfies the recommendation condition, the method further comprises:
performing configuration information identification on the target input information to obtain second configuration information;
determining a target application based on the second application and the second configuration information, wherein the target application is a second application capable of executing the target control information according to the second configuration information;
determining a target function, wherein the target function is to control the target application to execute instructions corresponding to the target control information, and the target function is set based on the second configuration information; and
displaying a shortcut control corresponding to the target function on the display interface of the terminal device.

4. The function recommendation method according to claim 3, wherein the second application is a countdown application.

5. The function recommendation method according to claim 1, wherein the target input information comprises third input information, and the method comprises:
performing configuration information identification on the third input information to obtain second configuration information;
opening an application interface of the at least one second application in response to an operation of the user on a first shortcut control; and
configuring the at least one second application based on the second configuration information, so as to switch the application interface of the at least one second application to a functional interface for executing the second configuration information.

6. The function recommendation method according to claim 5, wherein the second application is a countdown application.

7. The function recommendation method according to claim 1, wherein the target input information comprises first input information and second input information, and the performing the semantic parsing on the target input information to obtain the target control information comprises:
performing the semantic parsing on the first input information to obtain first target control information; and
performing the semantic parsing on the second input information to obtain second target control information;
wherein the determining the at least one second application that satisfies the recommendation condition based on the target control information comprises:
determining at least one second application for the first input information that satisfies the recommendation condition based on the first target control information; and
determining at least one second application for the second input information that satisfies the recommendation condition based on the second target control information;
wherein the displaying the shortcut control corresponding to the at least one second application on the display interface of the terminal device comprises:
displaying a shortcut control corresponding to the at least one second application for the second input information and a shortcut control corresponding to the at least one second application for the first input information on the display interface of the terminal device at the same time.

8. The function recommendation method according to claim 7, wherein the target input information comprises the first input information and the second input information, and the displaying the shortcut control corresponding to the at least one second application on the display interface of the terminal device comprises:
opening an application interface of the at least one second application for the first input information on the display interface in response to an operation of the user on the first shortcut control; and
closing the application interface of the at least one second application for the first input information, and opening an application interface of the at least one second application for the second input information on the display interface, in response to an operation of the user on the second shortcut control.

9. The function recommendation method according to claim 1, wherein after determining the at least one second application that satisfies the recommendation condition, the method further comprises:
determining a third application that satisfies the recommendation condition based on the target control information when the terminal device is in a network connection state, wherein the third application is a cloud platform application; and
displaying the shortcut control corresponding to the at least one second application and a shortcut control corresponding to the third application on the display interface of the terminal device at the same time.

10. The function recommendation method according to claim 1, wherein the method further comprises:
displaying prompt information on the display interface of the terminal device when the terminal device is in a non-network connection state, wherein the prompt information is used for prompting the user to check a network state of the terminal device;
generating a network setting icon on the display interface of the terminal device; and
displaying a network setting interface on the display interface of the terminal device in response to an interactive operation between the user and the network setting icon.

11. The function recommendation method according to claim 1, wherein the determining the at least one second application that satisfies the recommendation condition based on the target control information comprises:
matching the target control information with a plurality of applications in the terminal device to obtain first matching degrees; and
acquiring the at least one second application that satisfies the recommendation condition based on the first matching degrees.

12. The function recommendation method according to claim 1, wherein after obtaining the target control information, the method further comprises:
matching the target control information with a plurality of applications in the terminal device to obtain first matching degrees; and
acquiring at least one candidate second application that satisfies the recommendation condition based on the first matching degrees, wherein the recommendation condition is that the first matching degree is greater than a first matching threshold; and
sequentially displaying a shortcut control corresponding to the at least one candidate second application on the display interface of the terminal device according to a sequence of the first matching degrees of the at least one candidate second application.

13. The function recommendation method according to claim 1, wherein the method further comprises:
acquiring the target input information input by the user during the executing of the first application, wherein the first application is a handwriting application, the target input information is handwriting input information, and the handwriting input information is text information obtained by character recognition for handwriting trajectory point information;
performing the semantic parsing on the handwriting input information to obtain the target control information;
determining at least one of the second applications that satisfies the recommendation condition based on the target control information; and
displaying the shortcut control corresponding to the at least one second application on the application interface of the handwriting application.

14. The function recommendation method according to claim 13, wherein the handwritten input information is acquired by:
acquiring the handwriting trajectory point information input by the user, wherein the handwriting trajectory point information comprises at least one of: coordinate values of trajectory points, timestamps of the trajectory points, and states of the trajectory points;
acquiring a handwriting trajectory line graph based on the handwriting trajectory point information;
inputting the handwriting trajectory point information into a first branch of a character recognition network to obtain a first input feature, wherein the first input feature comprises time information of the trajectory points of the handwriting trajectory point information;
inputting the handwriting trajectory line graph into a second branch of the character recognition network to obtain a second input feature, wherein the second input feature does not comprise the time information of the trajectory points of the handwriting trajectory point information; and
combining the first input feature with the second input feature to obtain the handwritten input information.

15. The function recommendation method according to claim 1, wherein the target input information is voice input information, and the voice input information is acquired by:
acquiring voice information input by the user;
performing feature extraction on the voice information to obtain voice features; and
decoding the voice features based on a voice recognition model to obtain the voice input information.

16. The function recommendation method according to claim 1, wherein the performing the semantic parsing on the target input information to obtain the target control information comprises:
acquiring at least one clause based on the target input information;
performing word segmentation on a clause in the target input information to obtain a plurality of segmented words;
matching each of the plurality of segmented words with candidate control information to obtain a second matching degree; and
taking candidate control information with a second matching degree greater than a second matching threshold as the target control information.

17. The function recommendation method according to claim 16, wherein the candidate control information is acquired by:
acquiring a function type of each application in the terminal device;
grouping all of applications in the terminal device according to the functional type of each of the applications in the terminal device to obtain at least one application cluster, wherein functional types of applications in each application cluster are the same; and
taking a function type corresponding to each application cluster as one of the candidate control information.

18. The function recommendation method according to claim 16, wherein after obtaining the plurality of segmented words, the method further comprises:
taking a left segmented word and a right segmented word corresponding to each segmented word in the clause as classification input data to obtain a classification input data set; and
inputting the classification input data set into a classification model, and performing semantic parsing on the classification input data set based on the classification model to acquire the target control information.

19. A computing and processing device, comprising:
a memory with computer readable codes stored therein; and
one or more processors, wherein the computing and processing device executes the function recommendation method according to claim 1 when the computer readable code is executed by the one or more processors.

20. A non-transitory computer readable medium, storing a computer program comprising computer readable code, which, when executed on a computing and processing device, causes the computing and processing device to execute the function recommendation method according to claim 1.
